(19) United States
(12) Patent Application Publication
(10) Pub. No.: US 2015/0150296 A1
(43) Pub. Date: Jun. 4, 2015

(54) SAP AND LOW ACID FRUIT JUICE AND LOW ACID VEGETABLE JUICE PRODUCTS

(71) Applicant: FERONIA FORESTS, LLC, New York, NY (US)

(72) Inventors: Paolo Cugnasca, New York, NY (US); Michael L. Farrell, Lake Placid, NY (US)

(73) Assignee: FERONIA FORESTS, LLC, New York, NY (US)

(21) Appl. No.: 14/616,854

(22) Filed: Feb. 9, 2015

Related U.S. Application Data
(63) Continuation-in-part of application No. 14/567,775, filed on Dec. 11, 2014.
Application No. 14/567,775 is a continuation-in-part of application No. 13/690,420, filed on Nov. 30, 2012.
Application No. 13/690,420 is a continuation-in-part of application No. 13/572,745, filed on Aug. 13, 2012.
(60) Provisional application No. 61/939,481, filed on Feb. 13, 2014.

(51) Int. Cl. A23L 2/02; A23L 1/222

(52) U.S. Cl. CPC A23L 2/02; A23L 1/222; A23V 2002/00

(57) ABSTRACT

A beverage having an extended shelf life and process for the manufacture thereof in which a tree sap or low acid fruit juice or low acid vegetable juice is optionally adjusted to a standard pre-determined Brix value and then subjected to either (a) ultra-high temperature (UHT) pasteurization followed with aseptic packaging or (b) packaging followed by UHT. Additional sap and/or juice products having extended shelf life are also disclosed and claimed.

### CROSS-REFERENCE TO RELATED APPLICATIONS

This application is a continuation-in-part of each of the following co-pending applications and claims priority of each of co-pending US Provisional Application U.S. Ser. No. 61/939,481, filed, Feb. 13, 2014; co-pending non-provisional application U.S. Ser. No. 14/567,775, filed Dec. 2, 2014; co-pending non-provisional application U.S. Ser. No. 13/690,420, filed Nov. 30, 2012, and co-pending non-provisional application U.S. Ser. No. 13/572,745, filed Aug. 13, 2012.

Each of the foregoing applications is incorporated herein by reference in their entirety to the extent that they supplement, but do not contradict, the explicit disclosure herein.

### STATEMENT REGARDING FEDERALLY SPONSORED RESEARCH OR DEVELOPMENT

Not Applicable

### FIELD OF THE INVENTION

The present invention relates to sap as well as low acid fruit juices and low acid vegetable juices, sap products as well as low acid fruit juice products and low acid vegetable juice products, and particularly to beverages made from sap as well as beverages made from low acid fruit juices and/or low acid vegetable juices (but not including either “permeate” (defined below) or essentially pure water even though derived from a sap or from a low acid fruit juice or from a low acid vegetable juice). The invention further relates to “natural” ingestible products, especially beverages derived from a sap as well as beverages made from a low acid fruit juice and/or a low acid vegetable juice. In addition, the present invention also relates to products corresponding to the various saps or low acid fruit juice and/or vegetable products except that they are more concentrated and usable for other purposes, such as without limitation, flavoring agents. The present invention further relates to the use of ultra-high temperature pasteurization (UHT) in connection with assuring an adequate shelf life for a sap beverage, sap product, low acid fruit juice beverage, low acid fruit juice product, low acid vegetable juice beverage, or low acid vegetable juice product (a) followed by aseptic packaging or (b) using UI-IT as a terminal sterilization with or without (preferably with) prior aseptic packaging. “Aseptic packaging” or “aseptic packing” or “aseptically packing” are, throughout this disclosure, intended to mean packaging the respective material into aseptic containers under aseptic conditions. “Bottling” when used herein is intended to mean placing the respective materials into appropriate containers and when referring to bottling of the present invention, “bottling” is intended to mean placing the respective material into appropriate aseptic containers, under aseptic conditions or placing the respective material into aseptic containers and subjecting the material in the container to a terminal sterilization. Most preferably, “bottling” in the present invention includes placing the material into the aseptic container under aseptic conditions whether or not a terminal sterilization process is used. The invention also relates to the process of preparing the aforementioned in various sized packages, including without limitation package sizes for direct consumer use which are not intended for repackaging as well as industrial package size intended to be stored for some time and repackaged at some future date.

### BACKGROUND OF THE INVENTION

Maple and birch sap are naturally occurring, unprocessed crystal-clear liquids, having the consistency and clarity of water, which derives from maple or birch trees respectively (Acer spp or Betula spp respectively). Maple sap is generally available from maple trees during the late winter and early spring; sugar maple (Acer saccharum) is the most preferred species for maple sap collection though almost any species of maple is suitable. Nonetheless, in a preferred embodiment, the Korean maple known as Acer mono, (aka gorosoe) is preferably not a source of the maple sap used in the present invention. Birch sap is generally available from the birch trees during the early spring in the 2-3 weeks before the leaves open. Paper birch (Betula papyrifera), yellow birch (Betula alleghaniensis), and black birch (Betula lenta) are the preferred species for sap collection though any species of birch is suitable. Maple sap has a Brix value anywhere from approximately 1° to 5° Brix (the majority of the sugar content being sucrose); while birch sap has a sugar content anywhere from approximately 0.1° to 2.5° Brix (the majority of the sugar content being glucose and fructose). The remainder of the maple sap and birch sap content is naturally occurring water, electrolytes and minerals, and very small amounts of organic acids and/or esters, a portion of which is responsible for the characteristic maple and/or birch flavors, Maple sap and birch sap (whether or not concentrated or diluted) is not to be confused with the corresponding “maple syrup” or “birch syrup” which are the viscous liquids obtained by both concentration and heat treatment (generally boiling) of the corresponding sap. Because maple sap and birch sap are only available during a short season, products made therefrom are either available only during a short selling period or need to be processed in a manner which will give them sufficient shelf life to last from one production year to another. One manner of giving natural perishable products a longer shelf life than would otherwise be the case is pasteurization. Unfortunately, typical pasteurization (low temperature pasteurization as contrasted with Ultra-High Temperature Pasteurization (UHT) used in the present invention) still does not give the products such as maple sap and birch sap an adequate shelf life.

Low acid fruit and vegetable juices (those naturally having pHs in the range about 4.90 up to 7.00 (such as, without limitation, various species of the fruits and vegetables commonly known as beets, cantaloupe, carrots, celery, cucumbers, raspberries, papaya, pumpkin, strawberry, and watermelon—see Example 7 for the particular pH ranges associated with raw juices form this group), while available over larger growing seasons, still have concerns regarding preservation, especially for natural products that wish to avoid artificial preservatives. Thus, the raw juice, beverages other than the raw juice made from the juice, and more concentrated forms used especially for flavorings can also benefit from the instant invention processes. “Single strength” fruit or vegetable juices are neither significantly concentrated nor diluted with respect to the raw juice, and such are a preferred embodiment of the invention when discussing fruit juices or vegetable juices. In commercial contexts, it is preferable to have such fruit juices and vegetable juices as close to “natural” as possible, and this generally means avoiding the use of preservatives. Furthermore, in commercial contexts, the “fruit juice” and/or “vegetable juice” is frequently sold in two different distribution chains; one being a direct packaging of the juice in small containers, (generally of under 1 or two gallons, and usually much smaller sizes of from 1 to 10 serving sizes) for sale in such sizes to consumers; the other being in large commercial quantities (usually of at least one gallon in size) which are stored for various periods of time and then repackaged (generally by intermediaries) into consumer sizes for sale to consumers. The present invention relates to each of these packaged sizes.

Most people are familiar with the products maple syrup and maple sugar candy while some people are familiar with birch syrup (birch syrup is similar to maple syrup but has a much different flavor). Birch syrup is distinct from and vastly different than maple syrup, although both maple syrup and birch syrup are derived from the sap of the respective species.

As stated, maple sap usually has a typical Brix value of 1° to 5° Brix, sometimes 1° to 3° Brix, although it can be as low as 0.5 Brix or as high as 8 Brix, while birch sap usually has a typical Brix value of 0.1 to 2.5 more likely 0.4° to 1° Brix. (The degrees Brix is a scale that is used for measuring the density of sugar in solution. The “degrees Brix” (0° Brix) means that the solution under consideration has the same density as a solution containing a percentage of sugar numerically equal to the Brix value.) The sweetness of the fruit and vegetable juices referred to above vary over a wide range of Brix values, which will be apparent to those of ordinary skill in the art. The sweetness of fruits and vegetables also varies with whether the particular fruit or vegetable is “ripe” or not, as is known by virtually all.

In the production of maple syrup and birch syrup from their respective saps, the sap is collected and subjected to an initial filtration. It is collected for storage for further processing and may be subjected to an ultraviolet (UV) irradiation to control bacterial load during the pre-processing storage. The collected sap often has water removed, generally by a reverse osmosis process to obtain a “concentrated sap” or “concentrate”. The removed water (generally referred to as “permeate”, when the water removal process used is reverse osmosis) is usually treated as a waste product. In some instances of maple products, this “permeate” has sometimes been bottled and sold as a “maple water” in either flat or carbonated forms. These “maple waters” should not be confused with products of the instant invention which products of this invention are still maple sap which either has a desired Brix value or is concentrated or diluted to achieve a desired Brix value. These “maple waters” (that is permeates) (not of the present invention) are essentially pure water that is just derived from maple sap, but there has been a market created for such “water” as a beverage. It should be stressed that such non-present-invention “maple water” is NOT a maple sap or more concentrated or further processed maple sap of the invention and these are not interchangeable for one another. (However, it should be noted that in some embodiments of the present invention (“maple sap product”), because of the consistency/viscosity and color of the product of the invention resembles that of water, commercial products of the invention may in some embodiments be marketed as a “maple water”, BUT nonetheless these are “maple sap products” of the invention and are not the same as or equivalent to those “maple waters” previously discussed.) The concentrated sap is then boiled to remove additional water to result in the corresponding syrup. In the case of maple syrup production, the heat treatment of the concentrated maple sap to produce the maple syrup removes additional water, further concentrating the sugar content, and results in the “Browning” or “Maillard” Reaction (generating both the characteristic color and flavor of maple syrup). If still further water is removed, the sugars concentrate to a point that they crystallize out and can be recovered and sold as “maple candy”, “maple cream”, “granulated maple sugar”, and other maple products. Similarly, the permeate obtained from birch sap reverse osmosis, etc., which may also be referred to as “birch water” (not of the present invention), is essentially pure water that is just derived from birch sap.

Carbonated maple sap is described in U.S. Pat. No. 5,424,089 where it is stated that the stored maple sap is subjected to a pasteurization process (at least 178° F. for at least 3 minutes, typically about 200° F. for about 5 minutes) and then cooled to a temperature at which it will accept carbonation introduction.

US 2012/0027735 describes using maple sap, maple syrup, and other maple products as vehicles for probiotics, and discusses using heat sterilization at 121° C. or less for about 15 minutes in order to sterilize the maple product before introduction of the probiotic therein. The specification there emphasizes that in order to have the probiotic maintain its viability, the vehicle must be free of other bacterial load.

US 2005/0170047 discusses nutritionally enhanced maple syrup products.

US 2011/0081455, US 2009/0104312, US 2008/0226797, US 2008/0226798 and U.S. Pat. No. 8,029,846 briefly discuss UHT. US 2011/00023728 is a patent directed to specialty pasteurization equipment. U.S. Pat. No. 7,906,160 is directed to protein beverages and refers to sterilization without the use of thermal processing. U.S. Pat. No. 7,897,192 is directed to carbonated protein beverages and mentions ordinary pasteurization (140° F. to 188° F. for 10 seconds to about 60 seconds). Other family members of U.S. Pat. No. 7,906,160 and U.S. Pat. No. 7,897,192 are directed to protein beverages and some claims do and some claims do not mention the avoidance of thermal processing. U.S. Pat. No. 7,799,363 is one of those family members and mentions an alternate sterilization process—high pressure processing (HPP)—in claim 22 of that document in connection with such protein beverages.

US 2010/0178400 is directed to a whole grain beverage and the use of 275° to 305° F. for about 2-3 seconds (see claim 13 thereof).

### OBJECTS OF THE INVENTION

An object of the invention is to provide a sap beverage or product or a low acid fruit juice beverage or product or low acid vegetable juice beverage or product having a shelf life of at least 6 months post bottling.

Another object of the invention is to provide a sap beverage or product or a low acid fruit juice beverage or product or low acid vegetable juice beverage or product having a shelf life post bottling of at least 9 months.

A further object of the invention is to provide a sap beverage or product or a low acid fruit juice beverage or product or low acid vegetable juice beverage or product with a sufficiently long shelf life that such beverage or product may be sold and consumed across an entire year from a single season's sap harvesting, fruit harvesting, or vegetable harvesting respectively until additional such beverages or products can be produced and distributed from the following year's harvest.

Yet another object of the invention is to provide a method of obtaining a sap beverage or product or a low acid fruit juice beverage or product or low acid vegetable juice beverage or product free of chemical preservatives that has a shelf life of at least 6 months.

Yet another object of the invention is to provide a method of obtaining a sap beverage or product or a low acid fruit juice beverage or product or low acid vegetable juice beverage or product free of chemical preservatives that has a shelf life of at least 9 months.

A still further object of the invention is to provide a maple sap beverage, a birch sap beverage, or a low acid fruit juice beverage or low acid vegetable juice beverage that is a “natural” product and has a shelf life of at least 9 months.

A still further object of the invention is to provide a maple sap beverage, a birch sap beverage, or a low acid fruit juice beverage or low acid vegetable juice beverage that is a “natural” product and has a shelf life of at least 12 months.

Yet another object of the invention is to provide a cooking or flavoring product derived from maple sap, birch sap, a low acid fruit juice, or a low acid vegetable juice that is a “natural” product and has a shelf life of at least 6 months.

Still another object of the invention is to provide a cooking or flavoring product derived from maple sap, birch sap, a low acid fruit juice, or a low acid vegetable juice that is a “natural” product and has a shelf life of at least 9 months.

An even further object of the invention is to provide a cooking or flavoring product derived from maple sap, birch sap, a low acid fruit juice, or a low acid vegetable juice that is a “natural” product and has a shelf life of at least 12 months.

A still further object of the invention is to provide a process for the production of the aforementioned products.

An even further object of the invention is to provide a commercial scale production process for the above products.

Still other objects of the invention will be recognized by those of ordinary skill in the art.

### BRIEF SUMMARY OF THE INVENTION

These and other objects of the invention are surprisingly achieved by (a) obtaining an ingestible tree sap (preferably, not a bamboo sap, more preferably a sap of a maple or birch species, even more preferably a maple sap, most preferably a maple sap not including Acer mono sap) and/or a low acid fruit juice and/or a low acid vegetable juice, (b) optionally adjusting the Brix value to a preselected value in the range of 0.1° Brix to 15° Brix to obtain a Brix adjusted sap or juice respectively, (c) subjecting the sap (or Brix adjusted sap) or juice (or Brix adjusted juice) to ultra-high temperature pasteurization (UHT) to obtain a sterilized sap product, and (d) packaging the sterilized sap product in an aseptic manner into aseptic containers. If the packaging is conducted prior to the UHT, the packaging need not necessarily be done aseptically, but preferably is done aseptically so as to reduce the potential bio-load that the sterilization procedure must deal with. In a preferred embodiment no “electric field effect” sterilization (as discussed in KR 100497048) is used in connection with sap beverage or sap product sterilization. In another preferred embodiment, no “electric field effect” sterilization (as discussed in KR 100497048) is used in connection with fruit juice beverage, fruit juice product, vegetable juice beverage, and/or vegetable juice product sterilization. In another preferred embodiment, once the juice or sap or concentrate of either has undergone UHIT treatment, no other sterilization procedure is applied to the sap or juice or product in question before aseptic packaging thereof. It should be noted that the foregoing does not exclude the application of additional sterilization techniques to the contents of the packaged beverages, saps, juices or products once the aseptic packages have been opened or at a time point within a commercially reasonable time of the expiration dates even before opening the aseptically packaged saps, products, beverages, juices, etc. of the invention. Nonetheless, in preferred embodiments, such near expiration date or post opening of the aseptically packaged materials is not generally employed. Where repackaging is done (generally by large commercial repackagers in the distribution chain), such repackagers may use additional sterilization techniques without departing from the present invention, provided that had the repackaged item been left undisturbed in its original packaging of the invention for the time period indicated for the cfu/ml limitations, the cfu/ml limitation would have been met.

### BRIEF DESCRIPTION OF THE DRAWING

FIG. 1 is a flow chart of a large scale bottling operation of a beverage or non-beverage product of the present invention.

### DETAILED DESCRIPTION OF THE INVENTION

The present invention is directed to an ingestible sap beverage or product, a low acid fruit juice beverage or product, and a low acid vegetable beverage or product and especially to an ingestible sap beverage, a low acid fruit beverage, and a low acid vegetable beverage, wherein the ingestible sap beverage contains only ingestible sap, optionally additional water, and optionally additional flavorings (preferably natural flavorings); the low acid fruit juice beverages preferably contain only the low acid fruit juice, optionally additional water, and optionally additional flavorings (preferably natural flavorings); and the low acid vegetable beverages contain only the low acid vegetable juice, optionally additional water, and optionally additional flavorings (preferably natural flavorings). Mixtures of the various saps, fruit juices and/or vegetable juices referred to above are also possible where desired. In each of these cases, the “sap”, the “low acid fruit juice”, and the “low acid vegetable juice” can be the raw sap or juice or a Brix adjusted one. While the sap beverage or low acid fruit beverage, or low acid vegetable beverage or corresponding sap product or low acid fruit juice product, or low acid vegetable juice product of the invention can further contain artificial ingredients (such as artificial flavorings, artificial sweeteners, and preservatives) and natural sweeteners obtained from other sources, beverages of the invention and other products of the invention are substantially free of and more preferably completely free of any artificial ingredients and most preferably consist of only materials obtained from ingestible saps, low acid fruit juices, and/or low acid vegetable juices and optionally additional natural flavorings. Thus, in the most preferred embodiment of the invention, the invention contains only
(a) (1) an ingestible sap (optionally Brix adjusted), optionally additional water (most preferably permeate from the same type of sap),
   (2) a low acid fruit juice (optionally Brix adjusted), optionally additional water (most preferably permeate from the same type of juice),
   (3) a low acid vegetable juice (optionally Brix adjusted), optionally additional water (most preferably permeate from the same type of juice),
   (4) or various blends or mixtures thereof
(b) optional natural flavorings, and
(c) optionally additional natural sweeteners, but preferably no sweeteners obtained from sources other than components in (a) above.
   More preferably, the sweeteners used are derived only from the same type of sap, low acid fruit juice, or low acid vegetable juice that is in a particular product, and most preferably from the same species of the sap, low acid fruit juice, or low acid vegetable juice used in (a) above. Thus, a maple sap product or beverage, if needing to include additional sweeteners would preferably contain sweeteners obtained solely from maple sap, most preferably from the same maple species used as the source of the maple sap. The same is applicable to the birch sap products of the invention (beverage and non-beverage), the low acid fruit juice products of the invention (beverage and non-beverage), and low acid vegetable juice products of the invention (beverage and non-beverage). Nonetheless, the additional sweeteners may come from other sources if so desired without departing from the broadest scope of the present invention.

Throughout this specification, where a numerical value is indicated with the modifier “about”, the same numerical term without the modifier “about” is deemed disclosed as well. Where ranges are indicated, specific values between the values explicitly disclosed are deemed disclosed as well as if they had been specifically disclosed. Where limits are described in a Markush Group as in “a lower limit selected from . . . ” intermediary values between the explicitly recited values are deemed to have been disclosed as if they were explicitly recited therein. Where numerical limitations have been set forth with alternate units with one or more being recited within parentheses after the primary number recitation, the alternate in the parentheses may be rounded to the last digit explicitly shown, but is deemed to include a specific recitation of the exact conversion of the unit recited before the corresponding parentheses, the same as if such exact unit conversion had been explicitly recited. All patent and patent applications mentioned in this specification are hereby incorporated by reference to the extent that they supplement the present specification; however such incorporation shall not be construed to contradict statements explicitly made in this specification, and statements in two or more such patents or patent applications that are contradictory to each other shall simply not be considered as incorporated herein absent a specific incorporation herein of the particular passage of one or more of such documents.

A maple sap is obtained from a maple tree in late winter or early spring and a birch sap is obtained from a birch tree in the early spring in the same manner as the respective saps are obtained for the production of the corresponding syrup. On collection it is generally filtered to remove gross impurities such as twigs, bark, soil, insect parts, etc. generally using serial filtering with (usually up to three or more) filters sequentially of finer pore size using filters in the range of 1-100 micron pore size, preferably in the range of 1-10 microns pore size (the exact pore size being any that is convenient for use to remove the gross contaminants), and is usually (but optionally) subjected to a partial sterilization procedure such as (a) exposure to ultraviolet (UV)-irradiation, (b) standard pasteurization (under 100° C.) or (c) micro- and/or nano-filtration; however, it is preferable in the practice of the present invention that any partial sterilization at this point be a non-heat-treatment one; with UV-irradiation being preferred. The partial sterilization process step at this point is to allow the collected sap to be stored for a short period of time (up to a few days) before further processing. The collected and optionally stored sap is then optionally adjusted to a pre-determined Brix value (if needed) where the pre-determined Brix value is selected from a value of 0.1° Brix to a value of 15° Brix by (i) removing water therefrom if the Brix value is lower than desired and (ii) adding water if the Brix value is higher than desired, and frequently both are used to obtain the specific product Brix value desired. Preferably the water is selected from (a) drinking water, (b) distilled water, (c) de-ionized water, (d) sterile water, (e) a corresponding “sap” water (i.e. water derived from a the corresponding type of tree, typically a permeate obtained from a corresponding sap in the course of processing such corresponding sap into syrup). Thus, where water is to be added to a birch sap, generally a birch permeate from another birch sap sample is used, or water recovered in the conversion of another birch sap sample into birch syrup is used. Similarly, where maple sap is needed to be diluted, it is also done with the water or permeate recovered from processing other samples of maple sap. While it is preferable to use the same species of maple as both the sap to be diluted and the sample from which the “water or permeate” is derived, other species of the same type of sap can be used as the source of the diluting “water” or “permeate”. When working with the low acid fruit juices and the low acid vegetable juices, the same concepts apply. However, generally for use as a low acid fruit beverage or a low acid vegetable beverage, “single strength” juice (i.e., neither diluted nor concentrated) is preferred. Alternatively, if appropriate Brix value saps of the same type are at hand, some above the desired Brix value and some below the desired Brix value, they can be blended in appropriate proportions to arrive at an appropriately adjusted Brix value sap without departing from the invention. The same alternative can be applied to the low acid fruit juices and the low acid vegetable juices. The blending of different samples of the same type of juice generally allows for greater uniformity in batch to batch production (with respect to not only Brix value, but also with respect to all other constituents of the juice) without either concentration or dilution of the juice. The “water” used for dilution of the saps or juices may be (i) derived from an earlier stage of the processing of the respective sap, fruit juice, or vegetable juice which is then being processed or (ii) from another batch of the respective sap, fruit juice, or vegetable juice that has been (a) processed according to the invention or (b) processed in order to make another sap or juice material such as syrup or concentrate for flavoring; however, it is always preferable that unless specifically desired to mix different saps and/or fruits and/or vegetable components, that the “water” or permeate come from the same type of sap, fruit, or vegetable that is the main component of the invention beverage or invention product.

Although the Brix value of the sap (preferably maple or birch) product of the invention in question may vary from 0.1 to 15, for a beverage product, it is more typically in the range of a lower limit selected from 0.1 to about 6, still more preferably from about 0.2, about 0.3, about 0.4, about 0.5, about 0.6, about 0.7, about 0.8, about 0.9, about 1.0, about 1.2, about 1.4, about 1.5, about 1.6, about 1.8, and about 2.0 to an upper limit selected from about 6, about 5.5, about 5.0. about 4.5, about 4.0, about 3.5, about 3.0, about 2.8, about 2.6, about 2.5, about 2.4, about 2.2, and about 2.0. More highly preferred ranges for a maple beverage product have a lower end of the range selected from about 1.4, about 1.5, about 1.6, about 1.8, and about 2.0 to an upper end of the range selected from about 2.2, and about 2.0, and a most highly preferred beverage Brix value is about 2.0. In addition to the specifically recited endpoints of the various ranges specifically recited, the invention further includes each intermediary lower endpoint and each intermediary upper end point between those specifically stated as if each had been explicitly recited herein. More highly preferred ranges for a birch beverage product have a lower end of the range selected from about 0.3, about 0.4, about 0.5, about 0.6, about 0.7, about 0.8, about 0.9, and about 1.0 to an upper end of the range selected from about 2.0, about 2.1, about 2.2, about 2.3, about 2.4, about 2.5, bout 2.6, about 2.7, about 2.8, about 2.9, and about 3.0, and a most highly preferred beverage Brix value is selected from about 0.5, about 1.0, about 1.5, about 2.0, about 2.5, about 2.6, about 2.7, about 2.9, about 2.9, and about 3.0. In addition to the specifically recited endpoints of the various ranges specifically recited, the invention further includes each intermediary lower endpoint and each intermediary upper end point between those specifically stated as if each had been explicitly recited herein. Similar adjustments may be made for various juices, where desired, but as stated, the juice beverages of the present invention are preferably “single strength” and the only adjustments in Brix value, if any, is the blending of the juices of multiple samples of the same type of juice to achieve greater batch to batch uniformity than otherwise.

For non-beverage products, such as those used for cooking and flavoring other items or in making other food items or non-food items that utilize the respective juice or sap as an ingredient or raw material, the full range of the 0.1° to 15° Brix is completely suitable, but more preferably the pre-determined Brix value lower end of the range is selected from about 4, about 5, about 6, about 7, about 8, about 9, about 10 and the upper end of the range of the pre-determined Brix value is selected from about 15, about 14, about 13, about 12, about 11, and about 10. In addition to the specifically recited endpoints of the various ranges specifically recited for the non-beverage products of the invention, the invention further includes each intermediary lower endpoint and each intermediary upper end point between those specifically stated as if each had been explicitly recited herein.

While the same Brix value adjustment level selections can be chosen for the low acid fruit juices (beverage and non-beverage products) and for the low acid vegetable juices (beverage and non-beverage products) of the invention, preferably the low acid fruit juices and the low acid vegetable juices are not Brix adjusted beyond accounting for the level of sweetness encountered in “ripe” fruit or “ripe” vegetables as compared to the same from fruit or vegetables which are not ripe, but are still consumable. Most preferably, the low acid fruit juice and the low acid vegetable juice are not Brix adjusted at all.

Once the sap and/or juice has the appropriate desired Brix value (or the sap and/or juice that is not to be Brix adjusted), it is subjected to ultra-high temperature pasteurization (UHT) and generally packaged in aseptic containers of appropriate size under aseptic packaging conditions as a means of ensuring the appropriate sterility and shelf life, although the aseptic packaging conditions may be eliminated if the UHT is a terminal sterilization, but preferably, the aseptic packing conditions are still used even if the UHT is a terminal sterilization. Aseptic packaging techniques and equipment for liquid products is generally known in the food and drug product fields and such techniques are fully acceptable for use in the present invention and are usually employed (as set forth hereinbelow).

In the following, “post-bottling” is intended to mean after the invention material (i.e. beverage or non-beverage product of the invention, whether sap or fruit juice or vegetable juice) has (a) both been subjected to UHT and then placed aseptically into aseptic containers or (b) has been placed in aseptic containers (with or without such being done under aseptic conditions, preferably with being done under aseptic conditions) and subjected to a UHT terminal sterilization procedure. As used herein, the “time of bottling” is at the completion of both the placement in these containers and the UHT process; the various storage times mentioned herein begin to be measured from the aforementioned “time of bottling”. The desired post-bottling shelf life for the products of the invention, whether a beverage or non-beverage product, is selected from at least 6 months, at least 7 months, at least 8 months, at least 9 months, at least 10 months, at least 11 months, at least 12 months, at least 13 months, at least 14 months, and at least 15 months post-bottling. Of the above shelf lives, those of 9 months and longer are preferable, and those of a year or more are still more preferable. Most highly preferred shelf lives are those of at least 15 months as these allow for the most flexibility in maintaining the respective products in the chain of commerce continuously throughout the year with a reasonable time for consumption thereof until the beverage or non-beverage product of the invention from the next harvest reaches the shelf.

The means for obtaining the required shelf life in the present invention is the use of ultra-high temperature pasteurization (UHT), and in the situation where the liquid product is being transferred to after the UHT, such packaging is done aseptically. While it is possible to omit the aseptic packaging if such final packaging is done prior to the UHT step (i.e. using UHT as a terminal sterilization), it is preferred to still use aseptic packaging conditions even here as a means to limit the bio-burden that the terminal sterilization must deal with, and thus further assure adequate sterilization and shelf life. UHT processing of other products, such as milk and dairy products is known and it is further known that such processing of milk perceptibly changes the flavor and taste of milk so processed. It is also known that temperature processing of maple sap for the production of maple syrup by boiling (lower temperatures than in UHT, but for longer times) changes both the appearance and taste of the maple sap and that the same process changes the taste of birch sap when producing birch syrup. In addition, according to Kirk-Othmer, Encyclopedia of Chemical Technology, 5^{th} Edition 2006, Vol 18, pages 32-33 in discussing dairy products, states:
“In recent years, higher heat treatments, e.g., ultrahigh temperature (UHT)-short time has been applied in conjunction with clean filling of treated polyester bottles to produce extended shelf life (ESL) packaged products capable of up to 90 days of refrigerated shelf life.
In aseptic packaging, milk is sterilized, e.g. rendered free of microorganisms usually by UHT technologies. Simultaneously, high barrier paperboard-foil-plastic lamination or all plastic packaging material is sterilized often by hydrogen peroxide. The two are assembled in a sterile environment and package is sealed to produce sterile milk in a sterile package. The increased heat required for sterilization of the milk can lead to flavors different from those in pasteurized refrigerated milk. Aseptically packaged milk may be distributed at ambient temperature.”
   Thus, for a beverage product that is intended to be as close to a natural sap or natural juice as possible, ultra-high temperature processing would not appear to be a logical method to select for sterilization purposes, and in the absence of post UHT “aseptic packaging” and absence of UIT as a terminal sterilization step even the 90 day shelf life indicated would not be sufficiently suitable for the currently desired beverages and non-beverage products. Nonetheless, surprisingly, it has been found that such UHT processing with aseptic packaging or UHT as a terminal sterilization (with or without the aseptic packaging, but preferably with it) delivers both the desired sterility and much more extended shelf life and does not perceptibly alter the consistency, the look, or the taste of the sap (preferably maple or birch) or the juices so processed. For the present invention, UHT means subjecting the product to a temperature of at least 130° C., preferably at least 135° C., more preferably at least 137° C. for a time period of about 1 to about 10 seconds, preferably about 2 to about 6 seconds, more preferably about 2 to about 4 seconds. In addition, for the purposes of the present invention, the UHT temperature should not exceed about 150° C., preferably not exceed 145° C., still more preferably not exceed 140° C., and most preferably not exceed 139° C.

For the present invention, at the time of bottling (that is, once the beverage or non-beverage product is subjected to both being placed into an aseptic container and the UHT process step, in either order), the present invention products have a bacterial load of not more than 10 colony-forming units/mL (cfu/mL), more preferably not more than 5, still more preferably not more than 4, even more preferably not more than 3, yet more preferably not more than 2, even still more preferably not more than 1, and most preferably zero cfu/mL. In addition, the products of the present invention when stored at 4° C. for a period selected from 6 months have a bacterial load of not more than 10 colony-forming units/mL (cfu/mL), more preferably not more than 5, still more preferably not more than 4, even more preferably not more than 3, yet more preferably not more than 2, even still more preferably not more than 1, and most preferably zero cfu/mL, more preferably the bacterial load specified is present after storage for 7 months, still more preferably after 8 months, yet more preferably after 9 months, still more preferably after 10 months, even more preferably after 1 months, still even more preferably after 12 months, yet more preferably after 15 months, even more preferably after 18 months, still more preferably after 21 months, and most preferably after 24 months. In each of the above, the bacterial load limitation is met when measured on the day that the storage time specified is first met and a measure even as much as a day later should not be construed as not meeting the definition if it has been met on the particular day indicated. Thus, where the limitation is not more than 10 cfu/mL after storage for 6 months is met when a product has a bacterial load of 10 cfu/mL on the 6 month anniversary of bottling when stored at the recited condition, no change in the bacterial load thereafter to greater than 10 cfu/ml (even if measured on 6 months and 1 day after bottling, even though the longer storage limitation (such as not more than 10 cfu/mL at 7 months from bottling) would not be met) will remove the sap or juice beverage or non-beverage product from the scope of the claim in question. It should also be noted that the above recited storage conditions are merely present as a means to have a specific test for measuring the product shelf life and is not a limitation on the product (i.e. the product is not required to be stored at the stated conditions, except for testing a representative sample to determine if a product falls within the claims that require a shelf life limitation).

Still further, the beverages and non-beverage products of the present invention when stored at ambient temperature (21° C. to 25° C.) for a period selected from 6 months have a bacterial load of not more than 10 colony-forming units/mL (cfu/mL), more preferably not more than 5, still more preferably not more than 4, even more preferably not more than 3, yet more preferably not more than 2, even still more preferably not more than 1, and most preferably zero cfu/mL, more preferably the bacterial load specified is present after storage for 7 months, still more preferably after 8 months, yet more preferably after 9 months, still more preferably after 10 months, even more preferably after 11 months, still even more preferably after 12 months, yet more preferably after 15 months, even more preferably after 18 months, still more preferably after 21 months, and most preferably after 24 months. In each of the above, the bacterial load limitation is met when measured on the day that the storage time specified is first met and a measure even as much as a day later should not be construed as not meeting the definition if it has been met on the particular day indicated. Thus, where the limitation is not more than 10 cfu/mL after storage for 6 months is met when a product has a bacterial load of 10 cfu/mL on the 6 month anniversary of bottling when stored at the recited condition, no change in the bacterial load thereafter to greater than 10 cfu/ml (even if measured on 6 months and 1 day after bottling, even though the longer storage limitation (such as not more than 10 cfu/mL at 7 months from bottling) would not be met. It should also be noted that the above recited storage conditions are merely present as a means to have a specific test for measuring the product shelf life and is not a limitation on the product (i.e. the product is not required to be stored at the stated conditions, except for testing a representative sample to determine if a product falls within the claims that require a shelf life limitation). Also, it should be noted that this is an independent testing limitation from that at the 4° C. storage conditions in the preceding paragraph so that a product has the requisite storage shelf life if it meets either or both of this ambient temperature storage condition or the refrigerated (4° C.) storage condition of the preceding paragraph.

In commercial contexts, when either the beverages or the non-beverage products of the invention are initially packaged in large industrial containers and intended for repackaging before distribution to the consuming public, it is recognized that in the course of repackaging, such repackers may conduct additional sterilization procedures on the material being repackaged. Where such takes place, such further sterilization procedures do not operate to remove the material in question from the present invention provided that the storage limitations would have been met had the material been permitted to remain undisturbed for the full storage time in the aseptic package that contained the material at the time of bottling under the present invention.

Optional preservatives, sweeteners, and flavors can be selected from any of those known in the art, whether natural or artificial. However, it is preferable to only include natural ingredients in the present invention (and further, of the sweeteners, to only include sweeteners that arise from the same type of sap, fruit, or vegetable from which the main sap or juice is being used). With respect to flavorings, any flavoring known in the beverage art may be used, but again, preferably only natural flavorings are desired. Included, without limitation, as suitable flavorings for the instant invention are: apple, apricot, banana, Barbados cherry (acerola cherry). blackberry, blueberry, boysenberry, buckthorn, cardamom, cassia, cassis, cherry, choke cherry, cinnamon, coconut, clove, coffee, cola, coriander, cranberry, currant, date, dewberry, elderberry, fig, ginger, ginseng, gooseberry, grape, grapefruit, guava, huckleberry, kiwi, lemon, lime, litchi, loganberry, mandarin orange, mango, mulberry, olive, orange, papaya, passion fruit, peach, pear, pepper, persimmon, pineapple, plains berry, plum, pomegranate, pomelo, prairie berry, prune. quince, raspberry, rhubarb, root beer, rowan, saskatoon berry, sassafras, sloe, strawberry, tangerine, tangelo, tea, tomato, vanilla, and yerba mate and kona berry.

The instant invention can be used to prepare beverages and products and fill containers that are suitable size for immediate release into the commercial distribution of retail products for individual consumer use as well as to fill containers for industrial size use which includes large scale end users as well as commercial intermediaries who may store large containers for considerable periods of time before either sale thereof or repackaging into smaller containers for retail distribution and sale. While the present invention, in preferred embodiments, generally excludes use of additional sterilization procedures after the UHT procedure step discussed above, additional serilization procedures by others in the repackaging operation mentioned above in this paragraph after UHT and aseptic packaging have been completed and transferred to another entity do not operate to be an exclusion from the present invention. However, the storage testing of CFU/ml limits discussed above need to be met without any repackaging and supplemental sterilization after the UHT step in conjunction with the packaging into asceptic containers as discussed above.

### EXAMPLES

The following examples exemplify, but do not limit, the present invention.

### Example 1

### (a) Maple

A maple sap beverage product of the invention is prepared as set forth below:

A maple sap is obtained and filtered to remove gross impurities and subjected to UV-irradiation to partially sterilize the sap. The Brix value is measured and adjusted with reverse osmosis and addition of a maple water as needed to achieve a Brix value of about 2.0° Brix. The product is subjected to UHT at 135° C. for about 6 seconds and bottled in an aseptic package under aseptic conditions.

### Example 1

### (b) Birch

A birch sap beverage product of the invention is prepared as set forth below:

A birch sap is obtained and filtered to remove gross impurities and subjected to UV-irradiation to partially sterilize the sap. The Brix value is measured and adjusted with reverse osmosis and addition of a birch water as needed to achieve a Brix value of about 0.5° Brix. The product is subjected to UHT at 135° C. for about 6 seconds and bottled in an aseptic package under aseptic conditions.

### Example 2

### (a) Maple

A maple sap non-beverage product of the invention is prepared as set forth below:

A maple sap is obtained and filtered to remove gross impurities and subjected to UV-irradiation to partially sterilize the sap. The Brix value is measured and adjusted with reverse osmosis to achieve a Brix value of about 12.0° Brix. The product is subjected to UHT at 135° C. for about 6 seconds and bottled in an aseptic package under aseptic conditions.

### Example 2

### (b) Birch

A birch sap non-beverage product of the invention is prepared as set forth below:

A birch sap is obtained and filtered to remove gross impurities and subjected to UV-irradiation to partially sterilize the sap. The Brix value is measured and adjusted with reverse osmosis to achieve a Brix value of about 12.0° Brix. The product is subjected to UHT at 135° C. for about 6 seconds and bottled in an aseptic package under aseptic conditions.

### Example 3

### (a) Maple

A maple sap beverage product of the invention is prepared as set forth below:

A first maple sap is obtained and filtered to remove gross impurities and subjected to UV-irradiation to partially sterilize the sap. The Brix value is measured and found to be 3° Brix (in excess of the desired 2° Brix for a particular product). A second maple sap is obtained and filtered to remove gross impurities and subjected to UV-irradiation to partially sterilize the sap. The Brix value of the second maple sap is measured and found to be 1° Brix (below that of the desired Brix value for a particular product). Blending 1 part by volume of the first maple sap (3° Brix) and 1 part by volume of the second maple sap (1° Brix) yields 2 parts by volume of a blended maple sap having the desired 2° Brix value. The product is subjected to UHT at 135° C. for about 6 seconds and bottled in an aseptic package under aseptic conditions.

### Example 3

### (b) Birch

A birch sap beverage product of the invention is prepared as set forth below:

A first birch sap is obtained and filtered to remove gross impurities and subjected to UV-irradiation to partially sterilize the sap. The Brix value is measured and found to be 0.8° Brix (in excess of the desired 0.6° Brix for a particular product). A second birch sap is obtained and filtered to remove gross impurities and subjected to UV-irradiation to partially sterilize the sap. The Brix value of the second birch sap is measured and found to be in 0.4° Brix (below that of the desired Brix value for a particular product). Blending 1 part by volume of the first birch sap (0.8° Brix) and 1 part by volume of the second birch sap (0.4° Brix) yields 2 parts by volume of a blended birch sap having the desired 0.6° Brix value. The product is subjected to UHT at 135° C. for about 6 seconds and bottled in an aseptic package under aseptic conditions.

### Example 4

The products of Examples 1-3 are prepared except that after adjustment of the Brix value, the products are packaged aseptically before the UHT step and then subjected to UHT as a terminal sterilization step.

### Example 5

The products of Examples 1-3 are prepared except that after adjustment of the Brix value, the products are packaged non-aseptically before the UHT step and then subjected to UHT as a terminal sterilization step.

### Example 6

### Fruit and Vegetable Juices

Examples 1-5 are repeated using the following fruit and vegetable juices in place of saps mentioned in the earlier Examples. No Brix value adjustment is conducted.

| Example | Type of Fruit or | Typical pH |
|---|---|---|
| No | vegetable Juice | of raw Juice |
| Ex. 6A | Beets | 5.30-6.60 |
| Ex. 6B | Cantaloupe | 6.13-6.58 |
| Ex. 6C | Carrots | 5.88-6.40 |
| Ex. 6D | Celery | 5.70-6.00 |
| Ex. 6E | Cucumbers | 5.12-5.78 |
| Ex. 6F | Raspberry | About 6.27 |
| Ex. 6G | Papaya | 5.20-6.00 |
| Ex. 6H | Pumpkin | 4.90-5.50 |
| Ex. 6I | Strawberry | 5.50-6.50 |
| Ex. 6J | Watermelon | 5.18-5.60 |

### Example 7

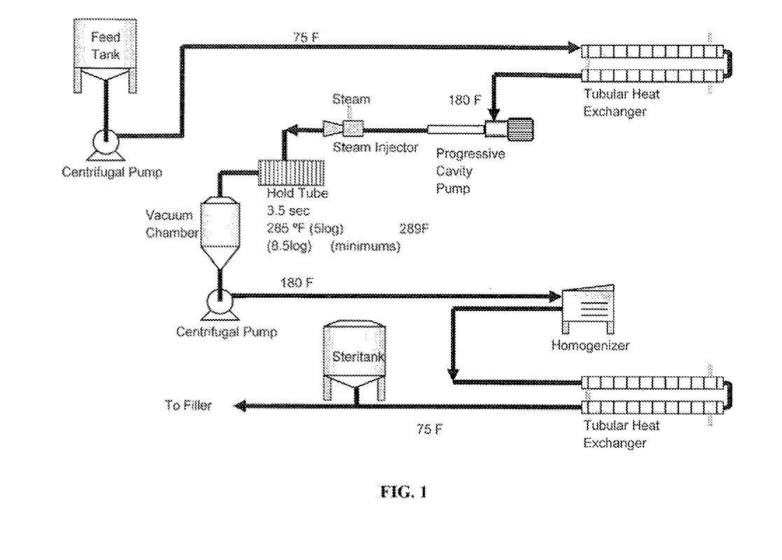

Sap is harvested and placed in a feed tank. From the feed tank, the sap is pumped at 75° F. into a tubular exchanger where the temperature is raised to 180° F. and transferred to a progressive cavity pump which pumps the sap into a steam injector at which time the temperature is raised 285° F. to 289° F. and held at that temperature in a holding tube for 3.5 seconds. From the holding tube the product enters a vacuum chamber and pumped therefrom at 180° F. into a homogenizer. After homogenization, the product enters a tubular heat exchanger where the temperature is lowered to 75° C. and held in a Steritank, after which it is transferred to a filler before going to final packaging. A flow chart of this process is provided as FIG. 1.

### Example 8

The fruit and vegetable juices mentioned in Example 6 are separately harvested and placed in respective feed tanks. From the feed tank, the juice is pumped at 75° F. into a tubular exchanger where the temperature is raised to 180° F. and transferred to a progressive cavity pump which pumps the juice into a steam injector at which time the temperature is raised 285° F. to 289° F. and held at that temperature in a holding tube for 3.5 seconds. From the holding tube the product enters a vacuum chamber and pumped therefrom at 180° F. into a homogenizer. After homogenization, the product enters a tubular heat exchanger where the temperature is lowered to 75° C. and held in a Steritank, after which it is transferred to a filler before going to final packaging. A flow chart of this process is provided as FIG. 1.

We claim:

1. A method of preparing a composition suitable for ingestion by a human comprising
(A) a first component selected from the group consisting of
(1) a tree sap selected from the group consisting of
(i) Acer sap other than the sap of Acer mono and
(ii) Betula sap,
(2) a low acid fruit juice,
(3) a low acid vegetable juice, and
(4) mixtures thereof,
said low-acid fruit juice and said low acid vegetable juice having a pH of from about 4.9 to about 7.0;
(B) an optional second component selected from one or more additional ingestible flavorings,
(C) an optional third component selected from one or more additional sweeteners, and
(D) an optional fourth component which is water which is separate from the water naturally present in the tree sap or low acid juice that is naturally present in said first component on a product-by-product basis;
said method consisting essentially of
(a) obtaining said first component;
(b) optionally subjecting said first component to a filtration step;
(c) optionally subjecting said first component to one or more partial sterilization processes selected from
(i) ultraviolet (UV) sterilization,
(ii) low temperature pasteurization, and
(iii) one or more of micro and nano filtration;
d) optionally adjusting the result of steps (a), (b), or (c) to a standard predefined Brix value;
e) optionally adding additional flavorings;
f) optionally adding an additional sweetener; and
g) subjecting the result of the accumulated foregoing steps (a), (b), (c), (d), and/or (e), whichever is used, to
(1) an ultra-high temperature pasteurization step followed by aseptic packaging or
(2) (i) optionally using aseptic conditions to package said product and
(ii) using UHT as a terminal sterilization step;
wherein said optional step (d) and optional step (e) and optional step (f) can each independently be done at any point after obtaining the sap until after said step (g), provided that if one or more of steps (d), (e), or (f) is performed after step (g), that the respective materials used therein after step (g) and the conditions of carrying out such steps be aseptic and conducted under aseptic conditions
whereby (a) said composition at the time of being placed into containers and having been exposed to said UHT step, has a micro-organism load of not more than 10 colony-forming units/mL (10 cfu/mL) and (b)(I) said composition on being stored at 4° C. for a period of 9 months has a micro-organism load of not more than 10 cfu/mL and/or (b)(II) said composition on being stored at a temperature of from about 20° C. to about 25° C. for a period of 9 months of not more than 10 cfu/mL.

2. The method of claim 1 which consists of:
(a) obtaining said first component;
(b) optionally subjecting said first component to a filtration step;
(c) optionally subjecting said first component to one or more partial sterilization processes selected from
(i) ultraviolet (UV) sterilization,
(ii) low temperature pasteurization, and
(iii) one or more of micro and nano filtration;
(d) optionally adjusting the accumulated result of steps (a), (b), and/or (c), whichever is used, to a standard predefined Brix value;
(e) optionally adding additional flavorings;
(f) optionally adding an additional sweetener; and
(g) subjecting the result of the accumulated foregoing steps (a), (b), (c), (d), (e) and/or (f), whichever is used, to
(1) an ultra-high temperature pasteurization step followed by aseptic packaging or
(2) (i) optionally using aseptic conditions to package said product and (ii) using UHT as a terminal sterilization step;
wherein said optional step (d) and optional step (e) and optional step (f) can each independently be done at any point after obtaining said first component until after said step (g), provided that if one or more of steps (d), (e), or (f) is performed after step (g), that the respective materials used after step (g) and the conditions of carrying out such steps be aseptic and conducted under aseptic conditions
whereby (a) said composition at the time of being placed into containers and having been exposed to said UHT step, has a micro-organism load of not more than 10 colony-forming units/mL (10 cfu/mL) and (b)(I) said composition on being stored at 4° C. for a period of 9 months has a micro-organism load of not more than 10 cfu/mL and/or (b)(II) said composition on being stored at a temperature of from about 20° C. to about 25° C. for a period of 9 months of not more than 10 cfu/mL.

3. The method of claim 1 which does not include an electric field effect sterilization procedure.

4. The method of claim 1 wherein said first component has a Brix value of about 0.1° Brix up to about 15° Brix and said composition has a Brix value of from about 0.1° Brix to about 15° Brix.

5. The method of claim 4 wherein said first component is said tree sap.

6. The method of claim 1 wherein water is added or removed to adjust the Brix value of said first component.

7. The method of claim 1 wherein said water is removed from said first component by reverse osmosis to result in a concentrated first component.

8. The method of claim 1 wherein water is added to said first component to result in a diluted first component.

9. The method of claim 8 wherein the water used to result in a diluted first component is selected from the group consisting of (a) tap water, (b) distilled water; (c) de-ionized water; (d) sterile water; (e) water derived from a sample of the corresponding sap, fruit juice, or vegetable juice, respectively, that is present in said composition first component on a product-by-product basis.

10. The method of claim 9 wherein the water used in claim 9 (e) is to dilute said first component is derived from
(a) a reverse osmosis process from
(i) said first component or
(ii) a second tree sap, second low acid fruit juice, or second low acid vegetable juice, respectively, of the same type as the particular said first component in said composition on a composition-by-composition basis or
(b) a process of converting said second tree sap, said second low acid fruit juice, or said second low acid vegetable juice, respectively to
(i) a corresponding concentrate or
(ii) a corresponding syrup; or
(c) converting a said corresponding concentrate into a corresponding syrup; or
(d) converting any the forgoing into another product whereby water is being removed therefrom.

11. The method of claim 1 wherein said UHT is conducted at a temperature of about 130° C. to about 150° C.

12. The method of claim 11 wherein said UHT is conducted at a temperature of about 135° C. to about 145° C.

13. The method of claim 1 wherein said UHT is conducted for a period of about 1 second to about 10 seconds.

14. The method of claim 13 wherein said UHT is conducted for a period of about 2 seconds to about 6 seconds.

15. The method of claim 1 wherein no additional sterilization procedure takes place after UHT sterilization other than aseptic packaging.

16. The method of claim 1 whereby said composition has a shelf life of at least 9 months after combined exposure to said UHT and being packaged in aseptic containers under aseptic conditions.

17. A method of preparing a composition suitable for ingestion by a human comprising
(A) a first component selected from the group consisting of
(1) a tree sap selected from the group consisting of
(i) Acer sap other than the sap of Acer mono and
(ii) Betula sap,
(2) a low acid fruit juice,
(3) a low acid vegetable juice, and
(4) mixtures thereof,
said low-acid fruit juice and said low acid vegetable juice having a pH of from about 4.9 to about 7.0;
(B) an optional second component selected from one or more additional ingestible flavorings,
(C) an optional third component selected from one or more additional sweeteners, and
(D) an optional fourth component which is water which is separate from the water naturally present in the tree sap or low acid juice that is naturally present in said first component on a product-by-product basis;
said method consisting essentially of
(a) obtaining said first component;
(b) optionally subjecting said first component to a filtration step;
(c) optionally subjecting said first component to one or more partial sterilization processes selected from
(i) ultraviolet (UV) sterilization,
(ii) low temperature pasteurization, and
(iii) one or more of micro and nano filtration;
(d) optionally adjusting the result of steps (a), (b), or (c) to a standard predefined Brix value;
(e) optionally adding additional flavorings;
(f) optionally adding an additional sweetener;
(g) placing the result of steps (a) through (f), whichever is used, into a feed tank,
(h) transporting said result at about 75° F. through a heat exchanger to raise the temperature to about 180° F. to result in a pre-UHT pre-heated material;
(i) exposing said pre-UHT pre-heated material to a steam injection unit to raise the temperature to 285° F. to 289° F. and holding it at 285° F. to 289° F. for a period of about 3.5 seconds to result in a UHT treated material;
(j) allowing the temperature of said UHT treated material to drop to about 180° F. and transporting the same to a homogenizer to result in a homogenized material;
(k) allowing the temperature to drop to 75° F. whole transporting said homogenized material (i) to a holding tank and then from said holding tank to a container filling apparatus or (ii) directly to a container filling apparatus
wherein said optional step (d) and optional step (e) and optional step (f) can each independently be done at any point after obtaining said first component provided that if one or more of steps (d), (e), or (f) is performed after step (i), that the respective materials used therein after step (i) and the conditions of carrying out such steps be aseptic and conducted under aseptic conditions
whereby (a) said composition at the time of being placed into containers and having been exposed to said UHT step, has a micro-organism load of not more than 10 colony-forming units/mL (10 cfu/mL) and (b)(I) said composition on being stored at 4° C. for a period of 9 months has a micro-organism load of not more than 10 cfu/mL and/or (b)(II) said composition on being stored at a temperature of from about 20° C. to about 25° C. for a period of 9 months of not more than 10 cfu/mL.

18. The method of claim 17 wherein no further sterilization effecting procedure is utilized after said step (i) except for said steps (j) and (k).

19. The method of claim 17 whereby said composition has a shelf life of at least 9 months after combined exposure to said UHT and being packaged in aseptic containers under aseptic conditions.

20. The method of claim 17 whereby said composition has a shelf life of at least 12 months after combined exposure to said UHT and being packaged in aseptic containers under aseptic conditions.

21. The method of claim 1 wherein said first component is selected from said low acid fruit juices and said low acid vegetable juices.

22. The method of claim 17 wherein said first component is selected from said low acid fruit juices and said low acid vegetable juices.

23. The composition produced by the method of claim 1.

24. The composition produced by the method of claim 17.

25. The composition of claim 23 which is a beverage.

26. The composition of claim 23 which is a flavoring or cooking product.

27. The composition of claim 24 which is a beverage.

28. The composition of claim 24 which is a flavoring or cooking product.

29. The composition of claim 1 suitable for use as an ingredient in another food or non-food product or as a raw material for use in preparing another food or non-food product.
